(19) United States
(12) Patent Application Publication
(10) Pub. No.: US 2002/0002469 A1
(43) Pub. Date: Jan. 3, 2002

(54) System and method for hiring lawyers and managing the process entailed in the pursuit of clients' legal claims

(76) Inventor: Scott Hillstrom, Eagan, MO (US)

Correspondence Address: Philip M. Weiss, Suite 305, 500 Old Country Road, Garden City, NY, 11530, US

(21) Appl. No.: 09/884,689

(22) Filed: Jun. 19, 2001

Related U.S. Application Data
(60) Provisional application No. 60/213,100, filed on Jun. 21, 2000.

(51) Int. Cl. G06F 17/60; G06F 7/00; G06F 17/00

(52) U.S. Cl. 705/1; 707/104.1

(57) ABSTRACT

The present invention is a system and method for hiring lawyers and managing the process entailed in the pursuit of clients' legal claims.

### FIELD OF THE INVENTION

The present invention relates to a system and method for hiring lawyers and managing the process entailed in the pursuit of clients' legal claims.

### BACKGROUND OF THE INVENTION

The legal services industry is highly fragmented and lacks meaningful quality controls. Fragmentation leads clients to select lawyers based on factors having little to do with the suitability of the choice. Advertising, personal relationships, word of mouth and the like frequently do not result in a good match of lawyers to clients. Meanwhile, the industry lacks meaningful quality controls. In most industries, customers can judge the quality and value of services for themselves. But, in the legal services industry, clients are not qualified to judge the quality or price of the services that they pay for because they lack the necessary expertise and experience. The mismatch of clients and lawyers, and the lack of quality controls, result in notoriously high levels of client dissatisfaction with lawyers generally.

Meanwhile, clients must make decisions that have profound effects on the outcome of their legal matters. They lack the expertise and experience necessary to understand issues and must depend on the advice of the lawyers that they hire. Often, they must make momentous decisions based on advice supplied by lawyers who are themselves lacking expertise or experience or who would benefit from the addition of another legal expert. And sometimes, lawyers' interests come into conflict with the client's: For example, when a lawyer recommends that a personal injury settlement offer be accepted under circumstances where the additional work necessary to try a case will/may not be justified by the additional fee he or she stands to earn doing it. Or when a corporation must make a critical decision with potentially large consequences but lacks its own expertise to judge whether or what legal advice to follow. These problems result from the way the legal industry operates even where lawyers are following ethical rules. The integration and quality control features of the present invention are designed to ameliorate these problems.

U.S. Pat. No. 5,838,966 relates to a computer aided system for organizing and explaining data stored by a legal professional and relating to a designated case where data is later required for action in a sequence of stages characteristic of a litigation proceeding.

U.S. Pat. No. 5,903,646 relates to an access control system for litigation document production. Documents are produced as stored images. Documents which are confidential or redacted are stored in encrypted form.

U.S. Pat. No. 5,956,687 relates to a personal injury claim management system. The system established records, each reflective of a phase of a corresponding personal injury claim.

U.S. Pat. No. 5,940,800 relates to attorney terminals which operate using an outline for storing, associating and managing case evidence, case law and work product for a given lawsuit at issue. The outline is structured based on a hierarchical categorization of the lawsuit into the law and fact at issue.

U.S. Pat. No. 5,875,431 relates to a legal strategic analysis planning and evaluation control system and method. The system relates to a computer based, closed loop legal strategic planning system having iterative convergence to an optimal strategy and dynamic tracking of current prevailing legal climates. The system provides a strategic planning template outlining the objectives and tasks, and their associated timing.

U.S. Pat. No. 5,991,733 relates to a method and computerized system for managing insurance receivable accounts. The method includes automation of collection strategies and a restorable data warehouse for comparison to all other insurance receivable accounts.

U.S. Pat. No. 5,159,180 relates to a litigation support system in which information regarding documents and other items of evidence are stored in record fields of an electronic database using an optical scanning mechanism with the ability to scan bar codes or other indicia.

### SUMMARY OF THE INVENTION

The present invention is a process and system for use by intra-state, multi-state, and international law firms and practices, including multi-disciplinary firms and practices (collectively herein “Practice (s)”), to select particularly qualified lawyers to pursue, prosecute, defend and manage legal claims on behalf of clients. It is a further object of the present invention to enable lawyers and clients to collaborate closely and to enable clients to take a pro-active role in the pursuit and management of their cases, claims, and defenses. It is an object of the present invention to collect, maintain, and use information about lawyers in a manner that improves the match of lawyers to clients and their legal matters and that assures that quality standards among lawyers are maintained. It is an object of the present invention for clients to pay lawyers for the use of the process and system from contingency fees and flat fees among other methods.

In an embodiment, the system of the present invention is used by a Practice or group of Practices consisting of “Managing Lawyers” dedicated to assisting clients to select lawyers and manage legal matters being primarily handled by other “Primary Lawyers” who may or may not be associated with the same Practice(s) as the Managing Lawyer. Primary Lawyers are lawyers who are primarily responsible for the execution of acts necessary to the proper handling of cases, claims, and defenses and who secure a continuous stream of referrals from the Practice by compliance with its policies, procedures, and standards. The system of the present invention assists Managing Lawyers and Primary Lawyers to improve the quality of legal services and results for their clients.

It is an object of the present invention to collect, maintain, and use information about lawyers in a manner that improves the match of lawyers to clients and their legal matters and that assures that quality standards among lawyers are maintained. It is an object of the present invention for clients to pay lawyers for the use of the process and system from contingency fees and flat fees among other methods.

In an embodiment, the system of the present invention is used by a Practice or group of Practices consisting of “Managing Lawyers” dedicated to assisting clients to select lawyers and manage legal matters being primarily handled by other “Primary Lawyers” who may or may not be associated with the same Practice(s) as the Managing Lawyer. Primary Lawyers are lawyers who are primarily responsible for the execution of acts necessary to the proper handling of cases, claims, and defenses and who secure a continuous stream of referrals from the Practice by compliance with its policies, procedures, and standards. Methods of the present invention includes using the Internet, broadcast, narrowcast, spot-cast, audio, video, electronic and print media for the generation of prospective client and lawyer inquiries and for processing and responding to such inquiries. Methods of the present invention include administrative processing and management of client inquiries, client accounts, client information and attorney client communications. This process is enabled by the use of an electronic and/or wireless network that makes its features and benefits available all the time, in real-time, worldwide and automates the processes necessary to the selection of lawyers and the management of legal matters.

### DETAILED DESCRIPTION OF THE INVENTION

A Practice uses the system and method of the present invention for the purpose of managing the process of pursuing, prosecuting, and defending legal claims of clients. The Practice manages legal claims through Managing Lawyers while Primary Lawyers, who may or may not be affiliated with the Practice, pursue, prosecute, and defend clients' legal matters.

A Practice consists of any association among lawyers and former judges (“Managing Lawyers”), active and retired, who possess unique skills, experience, and a license to practice law enabling them to provide management and advisory services to clients concerning legal matters being primarily handled by other “Primary Lawyers”. Lawyers may be associated in a Practice in any combination of personal contracts, corporations, partnerships, multidisciplinary practices, or other form allowed by law with the commonality among them being the use of the system and method. Lawyers interested in associating with the Practice as Managing Lawyers or Primary Lawyers may apply by mail, telephone or by using an electronic or wireless network included in the method and system of the present invention. Applicant lawyers undergo a specific process of selection and continuous qualification included in the method and system of the present invention.

The system and method of the present invention may be operated directly by a Practice or outsourced to a business management company.

In a preferred embodiment, prospective client and lawyer inquires are generated by marketing, promotion and advertising using the Internet, broadcast, narrowcast, spotcast, audio, video, electronic and print media. A publicly accessible website offers content, services and other attractions of interest to lawyers, clients, prospective clients and the people who serve them (e.g. doctors) and creates a vertically integrated marketplace of lawyers and clients by facilitating interactions among them. Users may access the public content and functions of the website by opening an account. While using publicly accessible content, services and functions, lawyer-users may apply on-line as Managing or Primary Lawyers. Prospective client-users may create and submit a file on-line answering questions that will enable the system of the present invention to forward the file to an appropriate Managing Lawyer licensed in an appropriate jurisdiction.

In a preferred embodiment, the present invention includes claim-type specific sections with content and features specific to specific types of claims (e.g. personal injury, insurance defense, environmental, class-action, etc.)

Lawyers' interested in associating with a Practice as a Managing Lawyer, or in receiving referrals from it as a Primary Lawyer, are enabled by the present invention to indicate their interest and to submit necessary information and records for consideration by the Practice. When a lawyer seeks to submit an application, they are electronically linked into a secure, confidential and proprietary Internet web site to enable (a) lawyers to indicate their interest in associating with or receiving referrals from the Practice and (b) prospective clients to use the services of the Law Firm.

Prospective clients are enabled to request information concerning a Practice's services or may inquire of a Managing Lawyer concerning their legal matters by submission of information over a secure link which information is accessible only to a Managing Lawyer licensed to Practice in an appropriate state or states and said lawyer is enabled to respond through a secure link directly back to the prospective client. The secure link connects users to an electronic encrypted file or files situated in a virtual private network accessible only by the lawyer and the prospective client using a password or other security measure.

Prospective clients are enabled to request to be contacted by a Managing Lawyer licensed in an appropriate state or states for consultation concerning the particular prospective client and claims.

In one embodiment of the present invention electronic and print media are used. The present invention uses the Internet, billboards, television, radio, magazines and newspapers for advertising and promotion. Persons responding to marketing, promotion and advertising contact the Practice by means of the Internet, telephone, fax, mail, and other means known in the art.

The present invention provides a unique way for prospective clients to respond. When a person does NOT request to be contacted by a Managing Attorney, the system of the present invention will answer general questions about the Practice and its services and will supply information requested by electronic and printed media.

When a person DOES request to be contacted by a Managing Attorney, the system of the present invention creates a data file including the name, phone number, address, email address and general description of the type of matter involved (collecting only what information is necessary to match the person to an appropriately qualified Managing Lawyer) and electronically refers the file to an appropriate Managing Lawyer who is preferably (but not necessarily) geographically convenient to the prospective client.

Upon receipt of a referral, a Managing Lawyer initiates contact with the prospective client by all available means within a prescribed number of hours of the initial contact. A normal telephonic and/or in-person consultation is conducted with the prospective client including collection and recording of relevant information and legally advising the prospective client. If the prospective client wishes to retain the Managing Lawyer the Managing Lawyer negotiates and executes a retainer agreement using the Practice prescribed standard retainer agreement (“SRA”) under which the prospective client becomes a client (“Client”) of the Practice. In a preferred embodiment, the provisions of the retainer agreement include the Client's consent to associate a Primary Lawyer approved by the Client; an attorney lien in favor of the Practice and Primary Lawyer; and the Client's consent to sharing of legal fees among the Practice and Primary Lawyer. Alternatively, the Managing Lawyer may refer the prospective client to a Primary lawyer before the SRA is signed. In that case, the Primary Lawyer is first retained using the SRA.

Lawyers interested in associating with the Practice, or receiving referrals from it, are invited to apply on-line and to submit information required by the Practice and necessary to process the application.

Managing and Primary Lawyers use the process and system of the present invention to comply with uniform quality assurance polices and standards established by the Practice to assure superior representation and results for Clients. In a preferred embodiment the process and system includes the following:

Electronic Process Control System (“EPCS”).

The present invention includes the use of a virtual private electronic network (“Network”) accessible through a browser or similar interface to access an EPCS. In a preferred embodiment, the present invention is primarily enabled by the use of the EPCS by some or all participants in initiating, executing, monitoring, and providing controls and statistical data for the workflow of the legal and administrative processes undertaken on behalf of clients. The EPCS may be used by the Managing Lawyer(s), Primary Lawyer(s), Client(s), Medical Personnel, Expert Witnesses or consultants, administrators, paralegal personnel, Defendants, Court Personnel, etc. or any of their assigns, (“Participants”). The Network uses standard Internet Protocol or other ubiquitous communications protocols. User participation is enabled by access to the EPCS via a standard web browser or equivalent, a custom application or its equivalent, or other access technology as may exist for networking functionality, such as wireless/mobile device access, access via an “internet appliance”, or telephone or “videophone” access, or any future equivalents, singly or in combination.

1) In a preferred embodiment, the EPCS provides the present invention with optimum efficiency, functionality, performance, reliability, and data regarding performance and client satisfaction. This may be accomplished via:

a) Central or distributed EPCS servers or replacement server technologies as appropriate to respond adequately to users' needs and desires.

b) Potential outsourcing of server hosting or other network functions to independent or allied entities to obtain maximum efficiency and user satisfaction.

c) Variants of the EPCS architecture, content, or functions to accommodate differing state or national laws as required to serve clients or users in disparate geographical locations.

2) The EPCS enables

a) Creation and storage of data files using pre-configured data fields selected or designed to hold information necessary to the process of pursuing, prosecuting and managing Clients' legal claims.

b) Organization of data files into functional structures consisting of data bases and rule based processes relating data files to one another and linking them or otherwise electronically associating them for ease of navigation and retrieval to relevant or related data files or documents as appropriate to the circumstances of each case. Among other things, the EPCS enables the creation, submittal, and storage of

i) clients' applications or requests for information, representation or evaluation.

Applications may include attachment or submittal of supporting documents or records as applicable.

ii) applications or requests for participation from Managing Lawyers, Primary Lawyers, or other participants interested in joining the network, such as medical personnel, expert witnesses or consultants, administrators, paralegal personnel, defendants, court personnel, etc. or any of their assigns. Applications may include questionnaires for assessing or issuing credentials, attached files of supporting documentation, referral information, and any additional data as may be required or appropriate to qualify applicants.

iii) necessary documents and forms including, but not limited to, retainer agreements, fact finding questionnaires, preliminary investigation reports, discovery proceedings and related document attachments, client authorizations for releases of information by medical record holders, employers, police or regulatory authorities, insurance companies, or other lawyers.

iv) notice letters and documents including, but not limited to service letters and notices of complaint, insurance company notifications, notices of power of attorney.

v) informational statements, statement of the case, deposition statements, various court documents and forms, documents utilized for integration with the internal processing systems of various participating law firms

vi) documents to control case work timelines and important dates.

(1) In a preferred embodiment, the EPCS includes automatic agents, macros, or other programmatic devices or methods to pro-actively generate reminders, alarms, or other notices via any medium including email, fax, or telephone, among others, notifying all relevant participants that due dates for various case work milestones or activities are pending or expired, that certain case work documents or participants have been inactive for specified amounts of time, that certain responses are lacking, that certain activities and/or communications have been initiated within the system. Documents and/or dates to be included are determined by the Practice and may additionally include, but are not limited to statutes of limitation, court filing deadlines, discovery (e.g. interrogatories) deadlines, expiration of settlement offers and response or comment documents or comments solicited from any involved parties.

(2) In a preferred embodiment, those portions of the automatically or manually generated messages which are transmitted between or among Participants via electronic email contain electronic linkages (via buttons, hotspots, “doclinks”, or other proprietary or commercially available features for electronic linkage) to the applicable documents or databases or system modules which caused the alarm or message. Additionally, the messages originating from this real-time date generator (e.g. electronic calendar) may include the following types of information, among others,

a. when specific actions are or should be scheduled to occur

b. retrospectively informing participants when

i. actions scheduled to occur have occurred, and

ii. actions scheduled to occur did not occur

(3) In a preferred embodiment, the automatic or manually generated alarms trigger a system of escalating alarms which send or copy the notifications to personnel or supervisory systems with progressively higher levels of authority and responsibility to enforce timely completion of scheduled or sequential events to help assure maximum client and user satisfaction. These escalating alarms enable certain participants to execute appropriate supervisory functions such as advising lawyers and clients of useful information that may assist in the matter concerning which the message was received

vii.) protection of confidentiality of information by limiting access to data bases and data files, and sharing of data files, to those participants who are authorized to access the information. Certain participants are permitted control over the access level settings of other participants, while certain other participants have various access levels such as to ‘read only’, ‘read and edit’, etc. In a preferred embodiment, creations of, or alterations to, certain documents by any participant force a description of the creation or revision and generate email or other notifications via appropriate media to participants related to the applicable case.

c.) archiving data files and linking them to databases including, among others,

a. Legal documents

b. Transcript

c. Pleadings

d. Medical and lab reports

e. Expert witness reports

f. Contracts

g. Correspondence

h. Graphic data

i. Photographs

ii. Scans, X-rays, medical and lab testing information

iii. Audio/video data

iv. Witness interviews

v. Depositions

d.) recording and transmission of live video and audio data of proceedings, including depositions, court hearings, trials, conferences and the like to Managing Lawyers and Clients; which further enables Managing Lawyers to participate when not physically present. Recordings are key-word searchable based on words describing subject matter imbedded for this purpose into recordings and also based on voice conversion into text extracted from recordings.

An embodiment of the present invention provides access to professional resources including, among others, standardized forms, retainer agreements, pleadings, settlement and other agreements identified to particular legal requirements in each state, expert witness roster, white papers, on-line legal research tools, legal research support personnel.

An embodiment of the present invention provides on-line submission of credentialing requirements and other information required by the Practice using the system to comply with policies, procedures and standards.

In a preferred embodiment of the present invention the process and system of the present invention includes a quality assurance process (“QAP”) designed to assure the maintenance of standards and compliance with policies calculated to ensure superior representation and results for Clients.

In a preferred embodiment, these standards include that all Managing and Primary Attorneys contractually agree to abide by the Practice's standards as a condition of association with the Practice, in the case of Managing Lawyers, or receiving referrals, in the case of Primary Attorneys. The Practice establishes and maintains a Standards Committee that sets professional standards for the Practice, Managing Lawyers and Primary Lawyers to whom they refer. The QAP includes:

i.) Credentialing Requirements (applicable to all lawyers). Only credentialed lawyers are permitted to serve as Managing or Primary Lawyers. Once granted, credentials automatically expire periodically at intervals set by the Standards Committee unless the lawyer's credentials are maintained. Lawyers maintain compliance with standards by supplying current credentialing information using the EPCS.

a. professional background, standing, and Practice

b. licensing status

c. disciplinary record

d. formal education

e. case type, load and results history

f. pro-bono and professional contributions

g. continuing legal education

h. professional and client references

i. malpractice insurance

j. law practice operations (applicable only to Primary Lawyers)

i. profitability and solvency

ii. access to financing resources for costs advanced against cases

iii. general management standards and Practice

iv. tax compliance

k. qualifications within declared specialty (e.g. auto accidents, medical malpractice , toxic torts, mass torts, etc.)

ii.) Peer Review. In an embodiment, a Standards Committee establishes a procedure for the periodic peer review of Managing Lawyers by the Standards Committee and Primary Lawyers by Managing Attorneys who refer to them. Peer review is automated through the EPCS using a procedure that enables clients and lawyers to make confidential entries into a secure file accessible only by authorized peer reviewers. An embodiment of the EPCS maintains on-line records of the quality performance of participants for purposes of assisting the Standards Committee in initiating and following up on appropriate corrective actions for deficiencies in client satisfaction, deficiencies in overall system performance, or unsatisfactory performance by any participant other than the Client. Additionally, an embodiment of the present invention includes the means to make certain awards, accolades, championship status, or other recognition of top performing participants as evidenced by the QAP data contained within the EPCS.

An embodiment of the EPCS includes hosting online games or contests wherein the general public can participate in any “participant” role in contests with or against certain champion participants in hypothetical cases.

An embodiment of the present invention includes integrating with a television, web cast, or other broadcast or narrow cast program, the content and plot of which coincides with, precedes, or results from hypothetical or actual case work within the EPCS. Integration can include the production of television programs, video, film, or other media presentations for education, commercial, or other purposes.

An embodiment of the present invention includes a Virtual Law School game that enables users to answer law school exam questions licensed from bar exam preparatory course. The exam database can be key word searchable so that users can find fact situations resembling their own case to become familiarized with the concepts involved.

An embodiment of the present invention includes EPCS capabilities to initiate, publicize, manage, and complete administrative and process flow work including all the above mentioned features pursuant to the organization, execution and settlement of classaction lawsuits involving multiple claimants.

An embodiment of the present invention includes Primary Lawyers being enabled to bid for the types of clients and cases they prefer by entering relevant data into the EPCS for use by Managing Lawyers in making referrals. Terms of bids can include any terms permitted by the Practice.

An embodiment of the present invention includes the use of the present invention to market and operate a center for multi-national litigation where the EPCS is used to coordinate litigation across multiple international jurisdictions. The service offers language translation services. The system can also assist in document production in a multi-district case.

An embodiment of the present invention includes offering consumers who pay contingent legal fees all of the benefits of the invention in consideration of referral fees customarily paid by primary lawyers to referring lawyers.

An embodiment of the present invention includes the classification of expert witnesses according to their fields (e.g. doctors, toxicologists, etc.) and inviting clients and lawyers, actual and prospective, to submit inquiries (e.g. “Ask the Expert”). Experts will be invited to log on and reply but the identities of each side will be known only to the Practice. Experts identities will be supplied to Primary Lawyers when they have replied in a matter which becomes a case. Experts are enabled to generate expert witness fees when their reply leads to an engagement.

In an embodiment of the present invention, the system of the present invention matches clients and their legal matters to the lawyers who serve them. Information about a client's case is inputted into the system of the present invention. Relevant information includes the jurisdiction where the legal matter occurred. For a personal injury matter, it would be where the accident occurred. Other information to be inputted the type of attorney a client needs, such as litigator, patent attorney, personal injury attorney, etc., personal information about the client, such as name address how to be contacted, etc. Information concerning the potential defendant should also be inputted so that conflict checks can be done so that the attorneys that are trying to be matched do not have a conflict with the potential defendants.

The system of the present invention will have in it's database information about the attorneys, managing attorneys and practicing attorneys. Information should include personal information, name, address, how to be contacted. Other information concerning their legal background also should be inputted. The legal background should include in what states the attorney is licensed, and the type of law that they specialize in. In a preferred embodiment, references from others who have had experience with the attorney is also inputted in the system of the present invention. In a preferred embodiment, the system of the present invention is linked to legal databases, such as westlaw, lexis and pacer, so that one can easily find any current information about how the attorney has done at trials or in opinions. In a preferred embodiment, the system of the present invention has a database regarding whether the attorney is in good standing, and whether they have any grievances filed against them. The legal information should be provided for both the Primary and Managing attorneys.

Based on the above information, the system of the present invention can assist a user in finding and evaluating both the Managing and Primary Attorneys.

enabling clients to participate meaningfully in the management of their legal matters;

instituting quality controls calculated to improve the quality of legal services and results to clients.

What is claimed is:

1. A process for matching clients to lawyers comprising:
inputting into a database information about a client's case;
inputting into a database information concerning an attorney's background; and
matching said client to an attorney based on said information.

2. The process of claim 1, further comprising:
inputting information about a potential defendant and eliminating said attorney as a match for said client if said attorney represents said defendant.

3. A system for matching clients to lawyers comprising:
a database;
said database comprising information about a client's case and information about attorney's backgrounds;
said system matching said client to an attorney based on said information.

4. The system of claim 3, wherein said database further comprises:
information about a potential defendant in regards to said client's case.

5. The system of claim 3, wherein said information about said client's case comprises:
jurisdiction of said case, type of attorney needed, and personal information about said client.

6. The system of claim 3, wherein said information about an attorney comprises:
personal information about said attorney, legal background of said attorney and references regarding said attorney.

7. A method for hiring lawyers and managing a case comprising:
receiving information about a client's case;
selecting a managing lawyer based on said client's case;
negotiating an agreement between said client and said managing lawyer;
said managing lawyer selecting a primary lawyer; and
electronically linking into a secured database said client, said managing lawyer, and said primary lawyer.
